(19) United States
(12) Patent Application Publication
(10) Pub. No.: US 2015/0193075 A1
(43) Pub. Date: Jul. 9, 2015

(54) TOUCH APPARATUS AND TOUCH METHOD THEREOF

(71) Applicants: Shih-Chieh Chang, Kaohsiung City (TW); Tsang-Chih Wu, Hsinchu City (TW)

(72) Inventors: Shih-Chieh Chang, Kaohsiung City (TW); Tsang-Chih Wu, Hsinchu City (TW)

(73) Assignee: ITE TECH. INC., Hsinchu (TW)

(21) Appl. No.: 14/250,394

(22) Filed: Apr. 11, 2014

(30) Foreign Application Priority Data
Jan. 6, 2014 (TW) 103100396

(51) Int. Cl. G06F 3/041

(52) U.S. Cl. CPC G06F 3/0418

(57) ABSTRACT

A touch apparatus and a touch method thereof are provided. At first, whether the touch apparatus is under the influence of the noise interference is determined according to a plurality of differences between a plurality of sensing values of adjacent touch sensing periods within a recent predetermined period. Then, a touch detection operating frequency of the touch apparatus is adjusted when the touch apparatus is under the influence of noise interference.

### CROSS-REFERENCE TO RELATED APPLICATION

This application claims the priority benefit of Taiwan application serial no. 103100396, filed on Jan. 6, 2014. The entirety of the above-mentioned patent application is hereby incorporated by reference herein and made a part of this specification.

### BACKGROUND

1. Technical Field

The invention is related to an electronic apparatus, and particularly, a touch apparatus and a touch operating method.

2. Description of Related Art

For a portable information technology (IT) products to have a user-friendly user interface, electronic apparatuses with touch panel has been the current trend nowadays. Panel manufacturers and integrated circuit (IC) design companies have made touch panel technologies their main research topic, and related techniques and products have been applied in electronic products of everyday life, as in IT products such as mobile phones, computers, and personal digital assistants (PDAs).

Presently, the touch apparatus are mainly categorized in a resistive type and a capacitive type. The operation principle of a capacitive touch apparatus is to sense an electrical characteristic referred to as capacitance. When two layers of electrical conductor approach each other without contacting each other, the electrical field between the two layers of electrical conductor forms the capacitance. The upper and lower layers of a touch panel structure are conductive layers respectively formed by electrical traces arranged in interlaced directions. A finger is also an electrically conductive object, and when the finger is placed on the touch panel, an extremely small capacitance is formed between the electrical traces of the touch panel and the finger. Accordingly, a microprocessor can detect the touch position of the user by using the capacitance variation.

Since, the touch apparatus may be affected by environmental changes, such as noise generated when the finger or other object contacts the panel or noise generated from the power supply, the electronic apparatus may generate false operations.

### SUMMARY

The exemplary embodiments of the disclosure provides a touch apparatus and a touch operating method thereof that avoids a touch result of the touch apparatus been affected by a noise interference.

The touch apparatus of the disclosure includes a touch sensing unit, a storage unit and a control unit. The touch sensing unit generates a plurality of sensing values corresponding to a plurality of touch sensing periods. The storage unit stores the sensing values. In addition, the control unit coupled to the touch sensing unit and the storage unit determines whether the touch sensing unit is under an influence of a noise interference according to a plurality of differences between the sensing values of the adjacent touch sensing periods within a recent predetermined period. Furthermore, the control unit adjusts a touch detection operating frequency of the touch apparatus if the touch sensing unit is determined to be under the influence of the noise interference.

According to an exemplary embodiment of the disclosure, the storage unit further stores a number of polarity changes for the differences between the sensing values of the adjacent touch sensing periods within the predetermined period. The control unit further determines whether the number of polarity changes is greater than a predetermined number, and the touch apparatus is determined to be interfered by the noises if the number of the polarity changes is greater than the predetermined number.

According to an exemplary embodiment of the disclosure, the storage unit further stores a plurality of predetermined operating frequencies, and the control unit further adjusts the touch detection operating frequency of touch apparatus according to the predetermined operating frequencies.

According to an exemplary embodiment of the disclosure, the control unit further adjusts the touch detection operating frequency by gradually increasing the touch detection operating frequency.

According to an exemplary embodiment of the disclosure, the storage unit further stores an optimal touch detection operating frequency corresponding to a minimum noise interference during the process of adjusting the touch detection operating frequency of the touch apparatus, where the control unit test and adjust the touch detection operating frequency within a predetermined frequency range. After the test of the touch detection operating frequency within the predetermined frequency range, the optimal touch detection frequency within the predetermined frequency range is set as the touch detection operating frequency of the touch apparatus.

According to an exemplary embodiment of the disclosure, the sensing values are generated by at least one of a touch operation of an input device or the noise inference.

The touch operating method of a touch apparatus includes a plurality of sensing values generated for different touch sensing periods within the recent predetermined period is stored. Whether the touch apparatus is under an influence of noise interference is determined according to a plurality of differences between the sensing values of the adjacent touch sensing periods. In addition, a touch detection operating frequency of the touch apparatus is adjusted if the touch apparatus is under the influence of noise interference.

According to an exemplary embodiment of the disclosure, the step of determining whether the touch apparatus is under the influence of noise interference according to the differences between the sensing values of the adjacent touch sensing periods includes the following steps. Whether a number of polarity changes of the differences between the sensing values of the adjacent touch sensing periods is greater than a predetermined number is determined. In addition, the touch apparatus is determined to be under the influence of noise interference if the number of polarity changes is greater than the predetermined number.

According to an exemplary embodiment of the disclosure, the step of adjusting the touch detection operating frequency of the touch apparatus includes a step of adjusting the touch detection operating frequency of the touch apparatus according to a plurality of predetermined operating frequencies.

According to an exemplary embodiment of the disclosure, the step of adjusting the touch detection operating frequency of the touch apparatus includes a step of gradually increasing the touch detection operating frequency of the touch apparatus.

According to an exemplary embodiment of the disclosure, the touch operating method of the touch apparatus further includes the following steps. An optimal touch detection operating frequency corresponding to minimum noise interference obtained during the step of adjusting the touch detection operating frequency of the touch apparatus is stored. A determination of whether a testing of the touch detection operating frequency of the touch apparatus within a predetermined frequency range is completed. In addition, the optimal touch detection operating frequency is set as the touch detection operating frequency if the testing of the touch detection operating frequency of the touch apparatus within a predetermined frequency range is completed.

According to an exemplary embodiment of the disclosure, the sensing values are generated by at least one of a touch operation of an input device or the noise inference.

Accordingly, the exemplary embodiments of the disclosure determines whether the touch apparatus is under the influence of the noise interference according to the differences between the sensing values of the adjacent sensing period within the recent predetermined period. When the touch apparatus is determined to be under the influence of the noise interference, the touch detection operating frequency of the touch apparatus is adjusted, so as to avoid the sensing result of the touch apparatus being affected by the noise interference. Thus, the touch performance of the touch apparatus is enhanced.

In order to make the aforementioned features and advantages of the present invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a block diagram illustrating a touch apparatus according to an exemplary embodiment of the disclosure.

FIG. 2A is a diagram illustrating a sensing result of a touch sensing unit while the touch apparatus is not under the influence of noise interference according to an exemplary embodiment of the disclosure.

FIG. 2B is a diagram illustrating the sensing result of the touch sensing unit while the touch apparatus is under the influence of noise interference according to an exemplary embodiment of the disclosure.

FIG. 3A is a diagram illustrating a plurality of differences between the sensing values of adjacent touch sensing periods illustrated in FIG. 2A.

FIG. 3B is a diagram illustrating a plurality of differences between the sensing values of adjacent touch sensing periods illustrated in FIG. 2B.

FIG. 4A is a diagram illustrating a number of polarity change for the sensing result corresponding to the exemplary embodiment illustrated in FIG. 3A.

FIG. 4B is a diagram illustrating a number of polarity change for the sensing result corresponding to the exemplary embodiment illustrated in FIG. 3B.

FIG. 5 is a flow diagram illustrating a touch operating method of a touch apparatus according to an exemplary embodiment of the disclosure.

FIG. 6 is a flow diagram illustrating a touch operating method of a touch apparatus according to another exemplary embodiment of the disclosure.

### DESCRIPTION OF EMBODIMENT

Reference will now be made in detail to the present preferred embodiments of the invention, examples of which are illustrated in the accompanying drawings. Wherever possible, the same reference numbers are used in the drawings and the description to refer to the same or like parts.

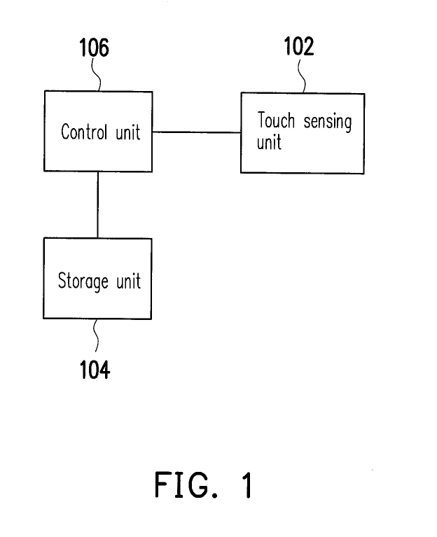

FIG. 1 is a block diagram illustrating a touch apparatus according to an exemplary embodiment of the disclosure. With reference to FIG. 1, the touch apparatus includes a touch sensing unit 102, a storage unit 104 and a control unit 106, where the control unit 106 is coupled to the touch sensing unit 102 and the storage unit 104. In the embodiment, the touch apparatus is, for example, a capacitive touch panel. However, the disclosure is not limited thereto, the touch apparatus may be a resistive touch panel. Furthermore, in the present embodiment, the touch sensing unit 102 is a smallest unit for sensing a touch event in the touch apparatus, where the touch apparatus may include a plurality of touch sensing unit 102. However, the disclosure is not limited thereto. In other exemplary embodiments, the touch sensing unit 102 may include a plurality of minimum units that executes touch detection.

The touch sensing unit 102 is configured to generate a plurality of sensing values for different touch sensing periods. The storage unit 104 is configured to store the sensing values. According to a plurality of differences between the sensing values of the adjacent touch sensing periods within a predetermined period, the control unit 106 may determine whether a sensing result of the touch sensing unit 102 is interfered by noises. If the sensing result is under the influence of noise interference, a touch detection operating frequency of the touch apparatus is adjusted to avoid noise interference on the sensing result, so as to enhance the touch performance of the touch apparatus. It should be noted that the sensing values may be generated by at least one of a corresponding noise interference or a touch operation of an input device. The input device may be a finger or a stylus, however, the disclosure is not limited thereto. The noise interference may be noises coming from a power supply end or a ground end, however, the disclosure is not limited thereto.

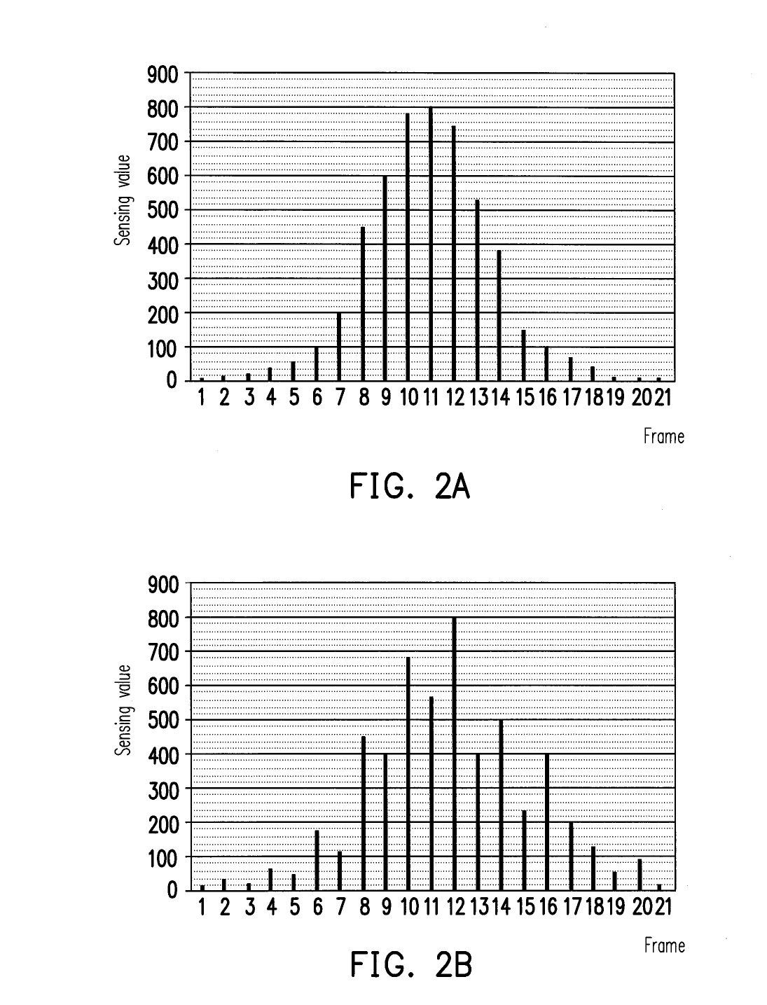

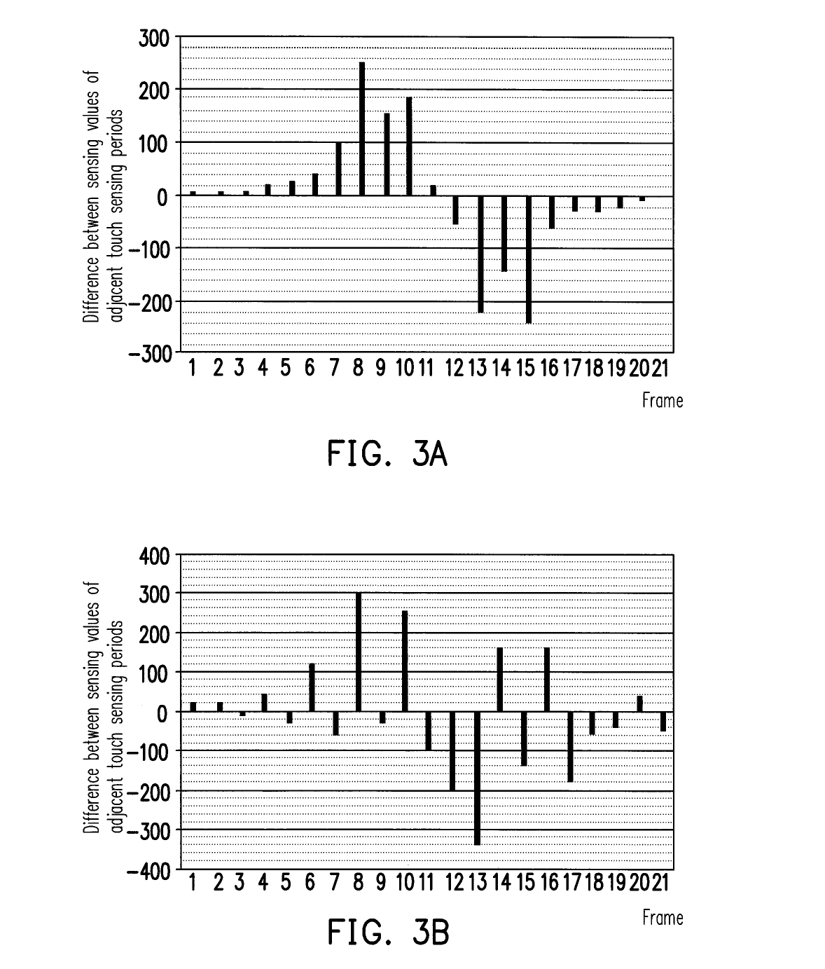

FIG. 2A is a diagram illustrating the sensing results of the touch sensing unit while the touch apparatus is not under the influence of noise interference according to an exemplary embodiment of the disclosure. FIG. 2B is a diagram illustrating the sensing results of the touch sensing unit while the touch apparatus is under the influence of noise interference according to an exemplary embodiment of the disclosure. The sensing results illustrated in FIGS. 2A and 2B is, for example, sensing results of a sliding operation, and different frames refers to different touch sensing periods. FIG. 3A is a diagram illustrating the differences between the sensing values of adjacent touch sensing periods illustrated in FIG. 2A. FIG. 3B is a diagram illustrating the differences between the sensing values of adjacent touch sensing periods illustrated in FIG. 2B. In other words, FIGS. 3A and 3B are diagrams respectively illustrating a result obtained by subtracting the sensing value of a previous touch sensing period (frame) illustrated in FIGS. 2A and 2B from the sensing value of a current touch sensing period (frame) illustrated in FIGS. 2A and 2B. Please refer to FIGS. 2A-3B for the following descriptions. With reference to FIG. 2A, when the touch apparatus is under the influence of noise interference, the sensing results of the touch sensing unit 102 within the predetermined period would have a normal pattern, where each of the sensing results gradually increases and then gradually decreases. On the other hand, with reference to FIG. 2B, when the touch apparatus is under the influence of noise interference, the sensing results of the touch sensing unit 102 within the predetermined period would have an abnormal pattern, where the sensing results of the different sensing periods may increase or decrease irregularly. Therefore, with reference to FIG. 3A, the differences between the sensing values of the adjacent touch sensing periods within the first half of the predetermined period, i.e., the differences obtained from subtracting the sensing value of the previous frame from the sensing value of the current frame, are positive values. On the contrary, the differences between the sensing values of the adjacent touch sensing periods within the last half of the predetermined period are negative values. However, as illustrated in FIG. 3B, due to the influences of the noise interference, the polarity of the differences between the sensing values of the adjacent touch sensing periods are less stable throughout the entire predetermined period. In other words, the polarity of the differences changes between positive and negative frequently.

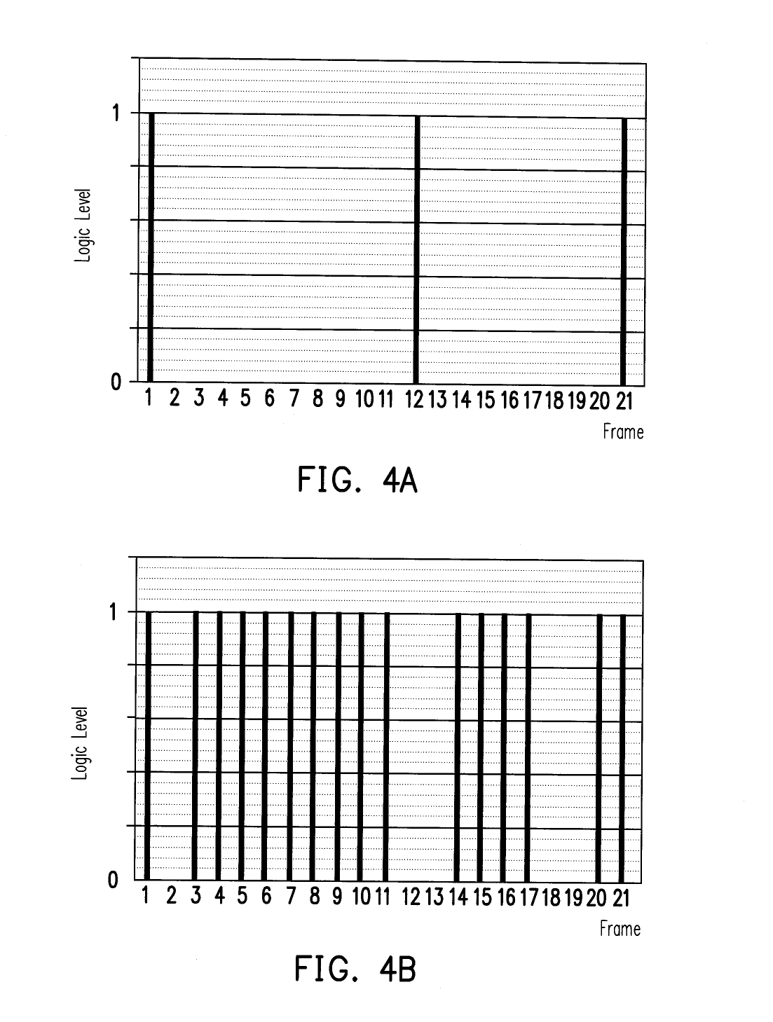

If the control unit 106 performs statistics on the number of times where the differences of the sensing values change its polarity within the predetermined period (which referred to as a number of polarity change), which are illustrated in FIGS. 3A and 3B, so that FIGS. 4A and 4B which illustrate the number of polarity change for the sensing values within the predetermined period may be obtained. In addition, the number of polarity change is stored in the storage unit 104. With reference to FIGS. 4A and 4B, when one of the differences illustrated in FIGS. 3A and 3B changes from zero to positive or negative values, from positive or negative values to zero, from positive value to negative value, or from negative value to positive value, a logic level corresponding to the current frame is set to 1. With reference to FIG. 4, when the touch apparatus is under the influence of the noise interference, the polarity of the differences between the sensing values merely changes 3 times (i.e., the number of polarity change is 3). On the other hand, with reference to FIG. 4B, when the touch apparatus is under the influence of the noise interference, the number of polarity change is as high as 16 times. Therefore, the control unit 106 may determine whether the touch apparatus is under the influence of the noise interference according to such characteristic. For example, the control unit 106 may determine whether the number of the polarity change is greater than a predetermined number (e.g., 8 times, but not limited thereto). If the number of polarity change is greater than the predetermined number, it is determined that the touch apparatus is under the influence of the noise interference.

When the control unit 106 determines that the touch apparatus is under the influence of noise interference, the touch detection operating frequency of the touch apparatus may be adjusted, so as to enhance the touch performance of the touch apparatus. In detail, the control unit 106 may adjust the touch detection operating frequency of the touch apparatus by selecting the touch detection operating frequency from a plurality of predetermined operating frequencies stored in the storage unit 104 or gradually increasing the touch sensing operating frequency of the touch apparatus. The method of adjusting the touch detection operating frequency according to the predetermined operating frequencies may be implemented by a lookup table, and the lookup table having the predetermined operating frequencies may be stored in the storage unit 104. During the process of adjusting the touch detection operating frequency of the touch apparatus, the storage unit 104 further renews and stores an optimal touch detection operating frequency corresponding to the minimum noise interference. In other words, when the control unit 106 determines that the number of the polarity change corresponding to the touch detection operating frequency currently selected is smaller than the number of polarity change corresponding to the optimal touch detection operating frequency stored in the storage unit 104, the optimal touch detection operating frequency stored in the storage unit 104 would be replaced with the touch detection operating frequency currently selected. In detail, the optimal touch detection operating frequency corresponding to the minimum noise interference may be obtained by testing a plurality of operating frequencies within a predetermined frequency range, and the optimal touch detection operating frequency may be stored in the storage unit 104. After the test is completed, the optimal touch detection operating frequency stored in the storage unit 104 may be set as the touch detection operating frequency of the touch apparatus. For example, after the predetermined operating frequencies stored in the control unit 106 are tested, the optimal touch detection operating frequency stored in the storage unit 104 is set as the touch detection operating frequency of the touch apparatus.

It should be noted that the exemplary embodiment illustrated in FIGS. 2A-4B are presented by utilizing the sliding operation as example. However, the application of the touch apparatus of the disclosure is not limited to the sliding operation. For example, the touch apparatus described above may also be implemented for a pressing operation. Furthermore, in other exemplary embodiments of disclosure, the aforementioned touch apparatus may be implemented for a situation where no touch operation has occurred to avoid fails touch operation due to the noise interference generated by the power supply or ground. In other words, the touch detection operating frequency of the touch apparatus may be adjusted without touching operations, so as to enhance the touch performance. Those of ordinary skill in the art would be able to deduce the implementation of the touch apparatus for the situation mentioned above through the embodiment illustrated in FIGS. 2A-4B, thus detail descriptions are omitted.

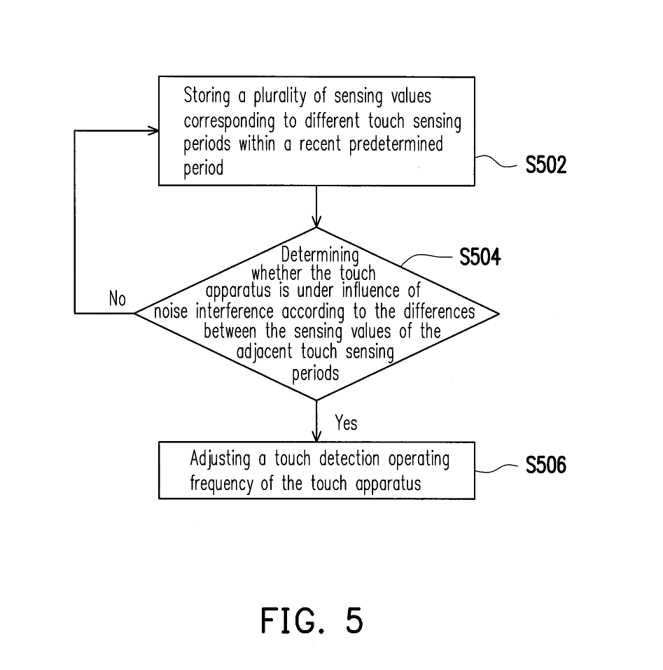

FIG. 5 is a flow diagram illustrating a touch operating method of a touch apparatus according to an exemplary embodiment of the disclosure. With reference to FIG. 5, the touch operating method of the touch apparatus may includes the following steps. First of all, a touch operation of an input device within a recent predetermined period is sensed, and a plurality of sensing values generated according to different sensing periods is stored (step S502), where the recent predetermined period includes a plurality of touch sensing periods. Next, whether the touch apparatus is under an influence of a noise interference is determined according to a plurality of differences between the sensing values of the adjacent touch sensing periods (Step S504). If the touch apparatus is under the influence of the noise interference, a touch detection operating frequency of the touch apparatus is adjusted (Step S506). For example, the adjustment of the touch detection operating frequency of the touch apparatus may be implemented by adjusting the touch detection operating frequency of the touch apparatus according to a plurality of predetermined operating frequency. Alternatively, the adjustment of the touch detection operating frequency may also be implemented by gradually increase the touch detection operating frequency of the touch apparatus. If it is determined that the touch apparatus is not under the influence of the noise interference, return back to step S502 to continue to sense the touch operation of the input device.

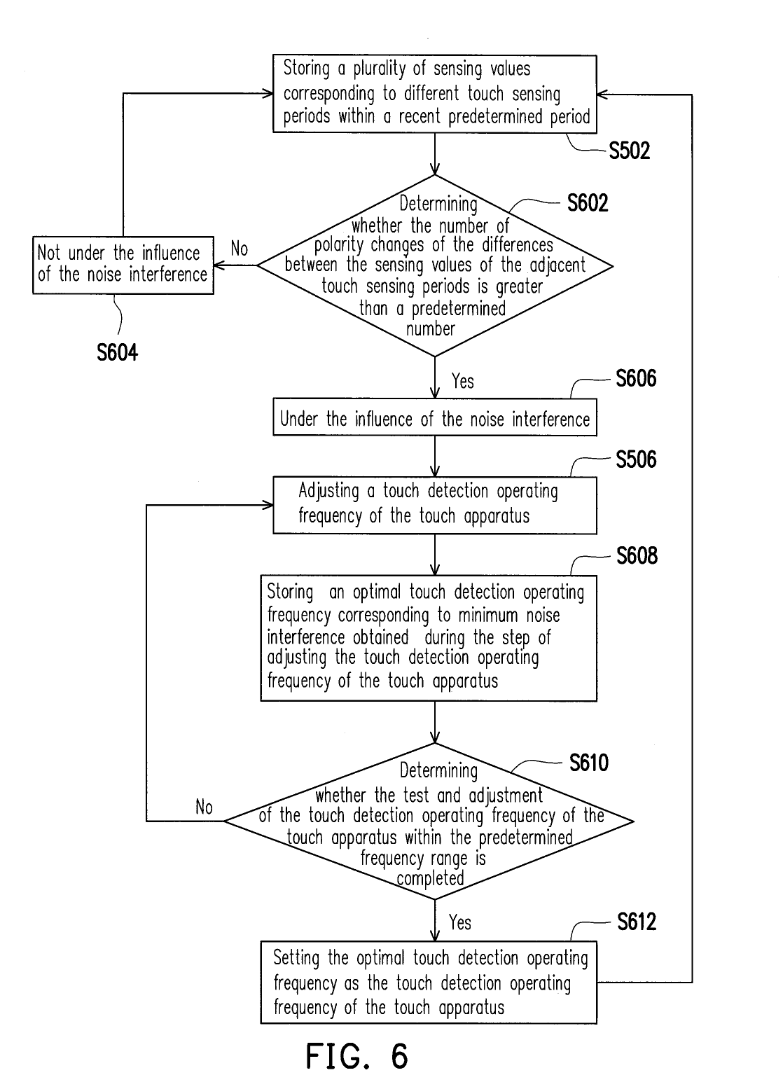

FIG. 6 is a flow diagram illustrating a touch operation method of a touch apparatus according to another exemplary embodiment of the disclosure. With reference to FIG. 6, in the present embodiment, the step of determining whether the apparatus is under the influence of noise interference according to the differences between the sensing values of the adjacent touch sensing periods may be implemented by determining whether a number of polarity changes between the differences of the sensing values of the adjacent touch sensing period is greater than a predetermined number (step S602). If the number of polarity changes is not greater than the predetermined number, it is determined that the touch apparatus is not under the influence of the noise interference (Step S604), and then return back to step 502 to continue to sense the touch operation of the input device. If the number of the polarity changes is greater than the predetermined number, it is determined that the touch apparatus is under the influence of the noise interference (Step S606), and then proceed to step S506 for adjusting the touch detection operating frequency of the touch apparatus. Furthermore, in the present embodiment, the touch operating method of the touch apparatus further includes the following steps. After step S506, an optimal touch detection operating frequency corresponding to a minimum noise interference is stored during the adjustment of the touch detection operating frequency of the touch apparatus (Step S608). Next, whether the touch detection operating frequencies of the touch apparatus within a predetermined frequency range are completely tested is determined (Step S610). If the touch detection operating frequencies within the predetermined frequency range are not completely tested, the process is returned back to the step S506 for adjusting the touch detection operating frequency of the touch apparatus. If the touch detection operating frequencies within the predetermined frequency range are not completely tested, for example, a plurality of predetermined operating frequencies are tested, so as to store an optimal touch detection operating frequency as the touch detection operating frequency of the touch apparatus (step S612). After step S612, the process is returned back to the step S502 to store the sensing values generated according to different sensing periods within a recent predetermined period.

In summary, the disclosure determines whether the touch apparatus is under an influence of the noise interference according to a plurality of differences between the sensing values of the adjacent touch sensing periods within a recent predetermined period. When the apparatus is under the influence of the noise interference, a touch detection operating frequency of the touch apparatus is adjusted, so as to avoid a touch result of the touch apparatus been influenced by the noise interference, so as to enhance the touch performance of the touch apparatus.

Although the present invention has been described with reference to the above embodiments, however, the present invention is not limited thereto. It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A touch apparatus, comprising:
a touch sensing unit, generating a plurality of sensing values corresponding to a plurality of touch sensing periods;
a storage unit, storing the sensing values; and
a control unit, coupled to the touch sensing unit and the storage unit, determining whether the touch sensing unit is under an influence of a noise interference according to a plurality of differences between the sensing values of the adjacent touch sensing periods within a recent predetermined period, and adjusting a touch detection operating frequency of the touch apparatus if the touch sensing unit is under the influence of the noise interference.

2. The touch apparatus as claimed in claim 1, wherein the storage unit further stores a number of polarity changes for the differences between the sensing values of the adjacent touch sensing periods within the predetermined period, and the control unit further determines whether the number of polarity changes is greater than a predetermined number, wherein the touch apparatus is determined to be under the influence of the noise interference if the number of polarity changes is greater than the predetermined number.

3. The touch apparatus as claimed in claim 1, wherein the storage unit further stores a plurality of predetermined operating frequencies, and the control unit further adjusts the touch detection operating frequency of touch apparatus according to the predetermined operating frequencies.

4. The touch apparatus as claimed in claim 1, wherein the control unit further adjusts the touch detection operating frequency by gradually increasing the touch detection operating frequency.

5. The touch apparatus as claimed in claim 1, wherein the storage unit further stores an optimal touch detection operating frequency corresponding to a minimum noise interference obtained during the step of adjusting the touch detection operating frequency of the touch apparatus, wherein the control unit further adjusts the touch detection operating frequency by testing a plurality of operating frequencies within a predetermined frequency range, after the test of the touch detection operating frequency within the predetermined frequency range is completed, the optimal touch detection frequency within the predetermined frequency range is set as the touch detection operating frequency of the touch apparatus.

6. The touch apparatus as claimed in claim 1, wherein the sensing values are generated by at least one of a touch operation of an input device or the noise inference.

7. A touch operating method of a touch apparatus, wherein a recent predetermined period comprises a plurality of touch sensing periods, comprising:
storing a plurality of sensing values generated for different touch sensing periods within the recent predetermined period;
determining whether the touch apparatus is under an influence of a noise interference according to a plurality of differences between the sensing values of the adjacent touch sensing periods; and
adjusting a touch detection operating frequency of the touch apparatus if the touch apparatus is under the influence of the noise interference.

8. The touch operating method of the touch apparatus as claimed in claim 7, wherein the step of determining whether the touch apparatus is under the influence of noise interference comprises:
determining whether a number of polarity changes of the differences between the sensing values of the adjacent touch sensing periods is greater than a predetermined number; and
determining that the touch apparatus is under the influence of noise interference if the number of polarity changes is greater than the predetermined number.

9. The touch operating method of the touch apparatus as claimed in claim 7, wherein the step of adjusting the touch detection operating frequency of the touch apparatus comprises adjusting the touch detection operating frequency of the touch apparatus according to a plurality of predetermined operating frequencies.

10. The touch operating method of the touch apparatus as claimed in claim 7, wherein the step of adjusting the touch detection operating frequency of the touch apparatus comprises gradually increasing the touch detection operating frequency of the touch apparatus.

11. The touch operating method of the touch apparatus as claimed in claim 7, further comprises:
storing an optimal touch detection operating frequency corresponding to minimum noise interference obtained during the step of adjusting the touch detection operating frequency of the touch apparatus;
determining whether an testing of the touch detection operating frequency of the touch apparatus within a predetermined frequency range is completed; and
setting the optimal touch detection operating frequency as the touch detection operating frequency if the testing of the touch detection operating frequency of the touch apparatus within a predetermined frequency range is completed.

12. The touch operating method of the touch apparatus as claimed in claim 7, wherein the sensing values are generated by at least one of a touch operation of an input device or the noise inference.
